(19) United States
(12) Patent Application Publication
(10) Pub. No.: US 2010/0202144 A1
(43) Pub. Date: Aug. 12, 2010

(54) Module structure of the LED lights and radiator

(76) Inventor: Gao-Shan Chen, Tainan (TW)

Correspondence Address: Gao-Shan, Chen, No.2, Alley 492, Sec.2, Hai Tien Rd., Tainan, 709, TW

(21) Appl. No.: 12/322,912

(22) Filed: Feb. 10, 2009

(51) Int. Cl. F21V 21/00

(52) U.S. Cl. 362/249.02

(57) ABSTRACT

The module structure of the LED light and radiator comprises a cover and a light module. The penetrating holes and retaining holes are set at the bottom of the container in the inner side of the bottom cover. The screw holes are set around the fitting holes. The light module comprises an aluminum base set with many screw holes corresponding with the screw holes on the bottom cover, a radiator, LED lights which are on the circuit board and a lamp mask. A circuit board thereon set a lamp mask with screws is below the aluminum base, and the radiator is set on the aluminum base.

### BACKGROUND OF THE INVENTION

1. Field of the Invention

This invention is related with the module structure of LED lights and radiator, especially for the light module comprises with aluminum base, radiators, LED lights and the lamp mask. The light module comprises LED lights and the radiator which can be fabricated and dismantled rapidly through the screws.

2. Description of the Related Art

“Assembled structure of large-sized LED lamps”, the prior invention, which is granted by No. 7338186 in US patent as shown in FIGS. 1 and 2, the prior invention comprises a cover, a radiator, an aluminum base, lights and a lamp mask. Several heat-dissipating holes are set on four sides of the cover. The radiator is set on top of the aluminum base. Fix the cover and the aluminum base, and cover the radiator in the cover. The lights are set at the bottom of the aluminum base and then fixed to the lamp mask. The lights comprise the LED lights and the circuit board.

However, the “assembled structure of large-sized LED lamps” mentioned above has the following shortcomings:
1. There are no penetrating holes setting on the aluminum base which can not allow the heat produced by the radiator and the LED lights scattered. Moreover, when things or water get into the cover, it can not be drained.
2. There are no penetrating holes on the aluminum base, therefore, the heat-dissipating holes can be only set on sides of the cover. Otherwise, it will cause lots of things getting into the cover and can not be obviated.
3. When changing or fixing the radiator, the aluminum base and the cover need to be dismantled. The structure of the prior invention is more complicated, and the design of the radiator and the LED lights is inconvenient for being fabricated and dismantled separately.

### SUMMARY

The present invention relates to a module structure of the LED lights and radiator which comprises a shell and a light module. A bottom cover set around with many heat-dissipating holes and a container which forms a containing space. Several penetrating holes and fitting holes are set at the bottom of the bottom cover. Several screw holes are set around the fitting holes. A light module comprises an aluminum base, radiator which is on the aluminum base, LED lights and a lamp mask. The screw holes on the surface of the aluminum base correspond to the screw holes on the bottom cover. A circuit board is set under the bottom of the aluminum base. The radiator is fixed on top of the aluminum base. LED lights are set on the circuit board which is at the bottom of the aluminum base. A lamp mask fixes the circuit board through screws.

### BRIEF DESCRIPTION OF THE DRAWINGS

FIG. 1 is a schematic drawing illustrating the prior invention.

FIG. 2 is a side view of the prior invention.

FIG. 3 is a schematic drawing illustrating the present invention of the light module.

FIG. 3-1 is a perspective view for the present invention of the light module.

FIG. 4 is a schematic drawing illustrating the present invention.

FIG. 5 is a perspective view for the present invention.

FIG. 6 is a side view of the present invention.

FIG. 7 is a schematic drawing illustrating the example of the present invention.

FIG. 8 is a schematic drawing illustrating the example for adding the penetrating holes on the retaining seat.

FIG. 9 is a schematic drawing illustrating the second example of the light modules.

FIG. 10 is a schematic drawing illustrating the second example for setting the radiators on the aluminum base.

### DETAILED DESCRIPTION OF THE INVENTION

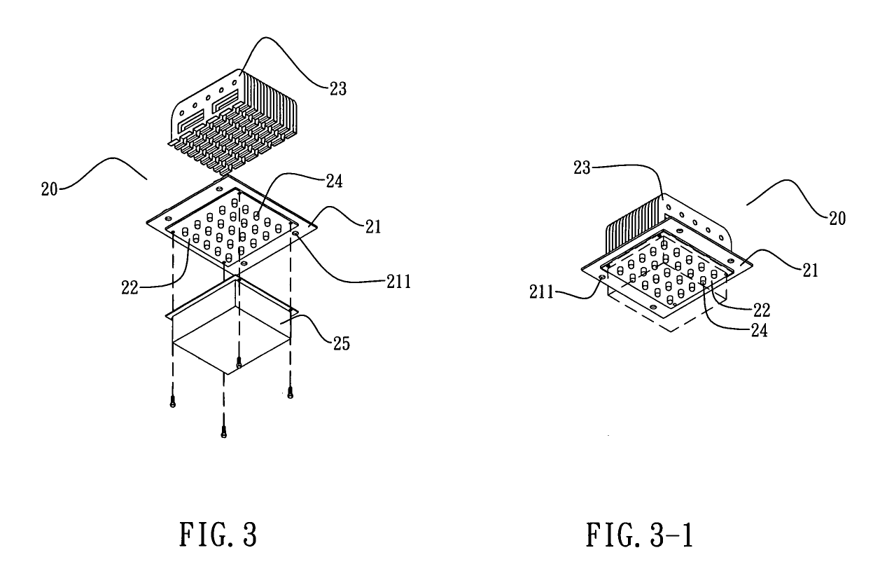

Referring to FIGS. 3 through 8, the module structure of the LED lights and radiator comprises a shell (10) and a light module (20). A shell (10) comprises a top board (11) and a bottom cover (12). Several heat-dissipating holes (111) which allow the air in are on the top board (11). A bottom cover (12) is set around with many heat-dissipating holes (124) and therein is a container (125) which forms a containing space. Several penetrating holes (121) and fitting holes (122) are set at the bottom of the bottom cover (12). Several screw holes (123) are set around the fitting holes (122).

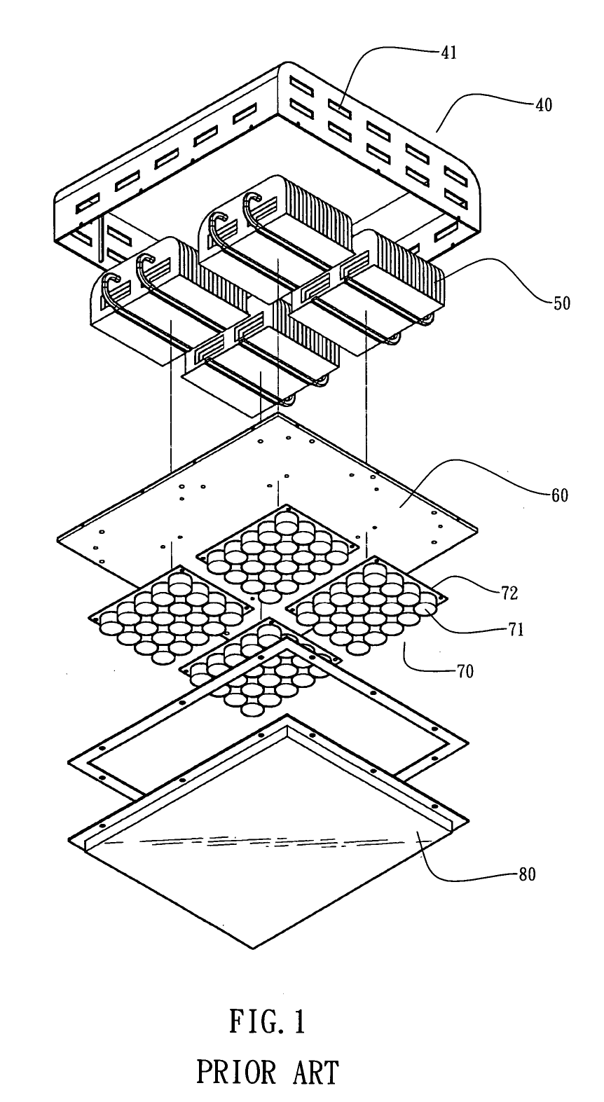

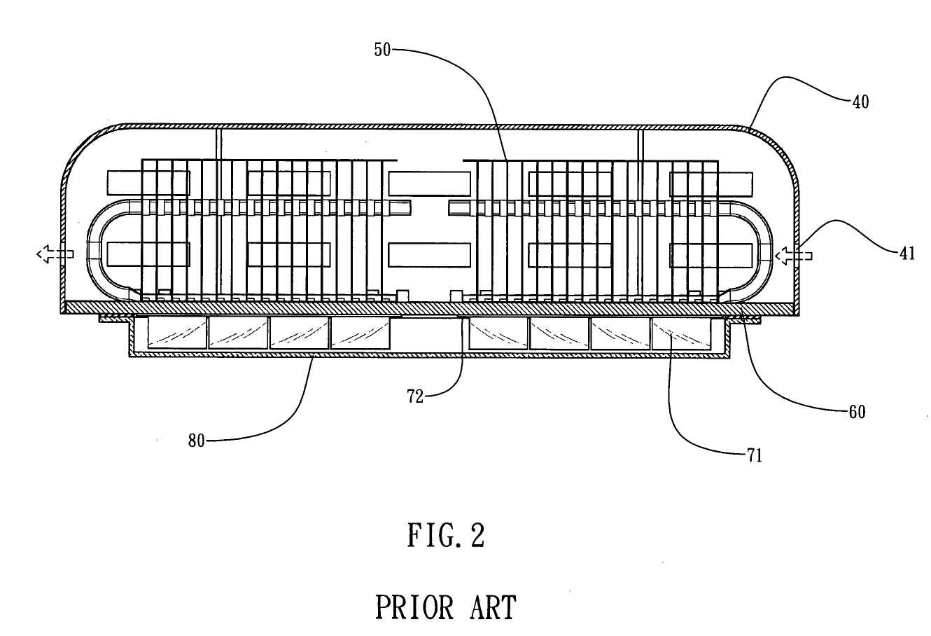

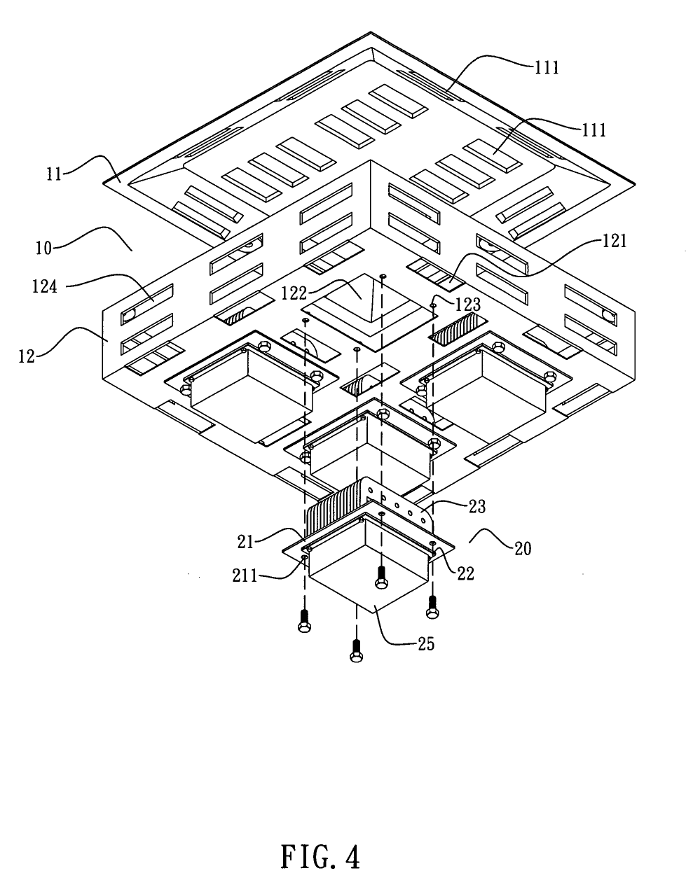

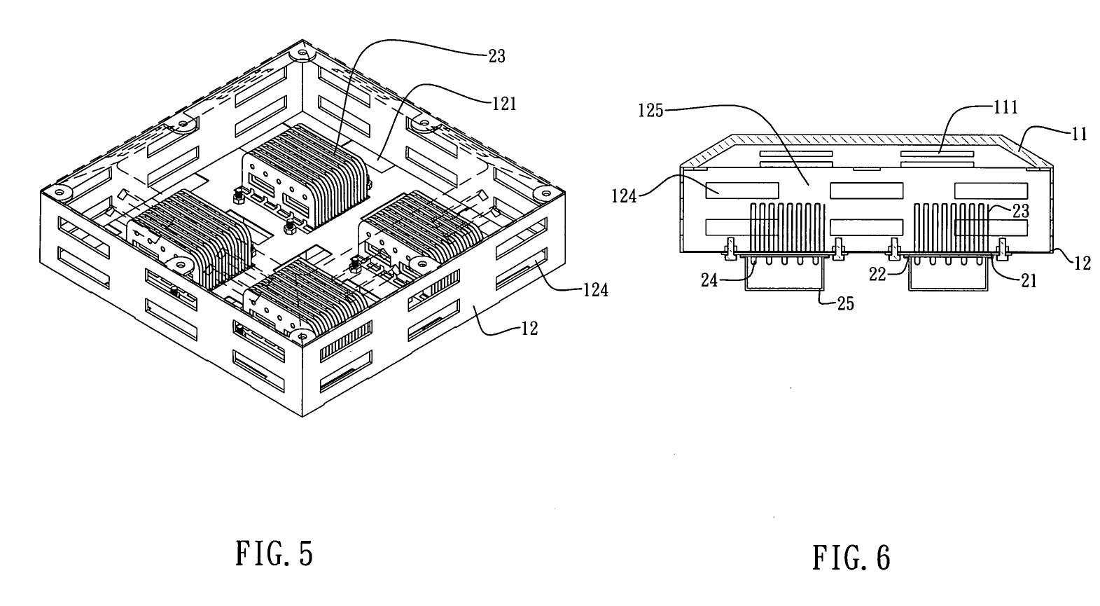

As shown in FIGS. 3 and 3-1, the light module (20) comprises a aluminum base (21), a radiator (23), LED lights (24) and a lamp mask (25). The area of the aluminum base (21) is bigger than the area of the fitting holes (122) setting at the bottom of the bottom cover (12). The screw holes (211) correspond to the screw holes (123) on the bottom cover (12). A circuit board (22) is set at the bottom. The radiator (23) is set on top of the aluminum base (21). The LED lights (24) are set on the circuit board (22) which is at the bottom of the aluminum base (21). A lamp mask (25) on the circuit board (22) is fixed through screws to cover the LED lights (24) in the lamp mask (25). As shown in FIG. 4, the radiator (23) of the light module (20) is on the top, the LED lights (24) and the lamp mask (25) are below; fix the screw holes (123) and the screw holes (211) correspondingly with screws, therefore, the light module (20) and the bottom cover (12) are connected. As shown in FIGS. 5 and 6, the area of the aluminum base (21) is bigger than the fitting holes (122), therefore, the aluminum base (21) can not move through the fitting hole (122), instead, it leans against the bottom of the bottom cover (12). The radiator (23) is set in the container (125) of the bottom cover (12) through the fitting hole (122).

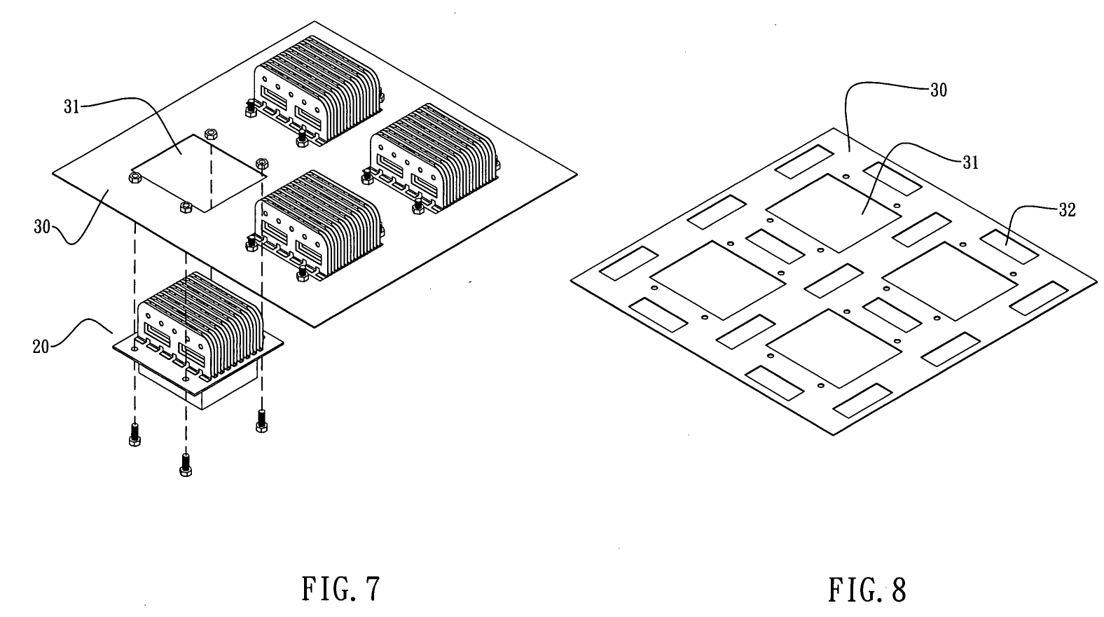

As shown in FIG. 7, this is the first example of the present invention. Replace the shell (10) with the retaining seat (30), and set the retaining holes (31) on the retaining seat (30). Set the light modules (20) in the retaining holes (31). Without the shell (10), the whole structure is better for heat-dissipating and water-draining, and it prolongs the using terms of the LED lights (24). As shown in FIG. 8, the penetrating holes (32) can be set around the retaining holes (31) of the retaining seat (30) to improve the effect of the water-draining.

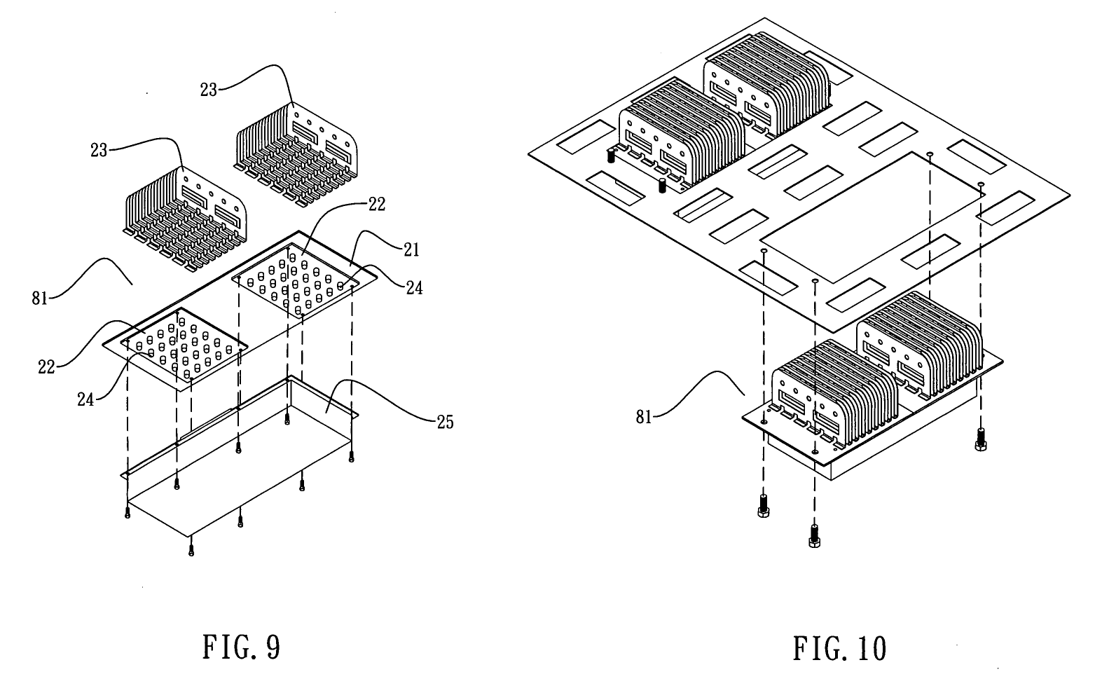

As shown in FIGS. 9 and 10, the light modules (81) comprise more than two individual light modules (20), which are shown in FIG. 7. More than two radiators (23) can be set on top of the aluminum base (21), and more than two circuit boards (22) and LED lights (24) can be set at the bottom covered by a lamp mask (25).

The present invention mentioned above has the advantages as following:
1. Several penetrating holes (32) are set on the bottom board, therefore, it speeds up the heat-dissipating of the light module (20) through the convection between the top and the bottom boards. Also, it prolongs the using terms of the LED lights (24). When things or water get into the shell (10), it can be easily drained away through the penetrating holes (32).
2. Because several penetrating holes (32) are on the bottom board, the heat-dissipating holes (111) of the top board (11) may set not only on the side, but also on the top. It can speed up the heat-dissipating effect between two boards.
3. The light module (20) of the present invention is a single light module (20). The single light module (20) comprises an aluminum base (21), a radiator (23), LED lights (24) and a lamp mask (25). The light module (20) can be easily fabricated in the fitting hole (122) on the shell (10) or be easily dismantled. An individual light module (20) can be changed when fixing instead of taking down whole structure of the module and then installing parts of the module back. The present invention will save more time and reduce the difficulty on fixing than the prior invention.

I claim:

1. A module structure of the LED light and radiator comprising:
a shell including a top board with several heat-dissipating holes which allow the air in and;
a bottom cover set around with many heat-dissipating holes and a container wherein forms a containing space;
penetrating holes and fitting holes are set at the bottom of said bottom cover;
screw holes are set around said fitting holes to fix the light module through said fitting holes;
a light module comprising an aluminum base, a radiator which is on said aluminum base, LED lights and a lamp mask;
wherein said screw holes on the surface of said aluminum base corresponding to said screw holes on said bottom cover;
a circuit board setting at the bottom of said aluminum base;
LED lights setting under said circuit board;
A lamp mask covering said circuit board and said LED fixed lights through screws;
the area of said aluminum base is bigger than the area of said fitting holes;
said aluminum base leaning against the bottom of said bottom cover;
said radiator setting in said container of said bottom cover through said fitting holes.

2. A module structure of the LED light and radiator as recited in claim 1, wherein said shell can be replaced with a retaining seat which retaining holes are set thereon, and penetrating holes may or may not be needed.

3. A module structure of the LED light and radiator as recited in claim 1, wherein light modules comprise more than two individual light modules, which means more than two radiators can be set on top of said aluminum base, and more than two circuit boards and LED lights can be set at the bottom of said aluminum base; said light modules are covered with said lamp mask.
